(19) United States
(12) Patent Application Publication
(10) Pub. No.: US 2017/0355570 A1
(43) Pub. Date: Dec. 14, 2017

(54) GAP PROTECTIVE DEVICE

(71) Applicant: Otis Elevator Company, Farmington, CT (US)

(72) Inventors: Tadeusz Pawel Witczak, Bethel, CT (US); Bruce P. Swaybill, Farmington, CT (US); Arthur Hsu, South Glastonbury, CT (US); Randall Roberts, Hebron, CT (US); Richard J. Ericson, Southington, CT (US)

(21) Appl. No.: 15/179,166

(22) Filed: Jun. 10, 2016

(51) Int. Cl. B66B 13/28; B66B 13/14; B66B 5/00

(52) U.S. Cl. CPC B66B 13/28; B66B 5/0087; B66B 13/14

(57) ABSTRACT

A protective device for a transportation system, wherein the protective device is disposed at each platform landing in a shaft and configured to direct falling objects away from moving components of the transportation system within the shaft.

### TECHNICAL FIELD OF THE DISCLOSED EMBODIMENTS

The present disclosure is generally related to transportation systems and, more specifically, a gap protective device.

### BACKGROUND OF THE DISCLOSED EMBODIMENTS

Transportation systems having sliding doors are increasingly common. One particular type of such a system, elevators may be found in office buildings and large apartment buildings, for example. When an elevator cab is disposed in an elevator shaft adjacent to a landing platform for a floor of a building, and any doors between the elevator and the platform are opened, passengers and cargo are permitted access to the elevator through an entrance defined between the cab and the landing platform. The entrance typically includes a small gap between the cab and the landing platform into the elevator shaft.

For passengers and cargo using an elevator there is a chance, when passing through the entrance, that an item may be dropped which happens to pass through the gap. In hoistways, the dropped object may interfere with other elevator components or, in elevator systems with more than one car in a hoistway, hit an elevator cab below. In some situations, the dropped object becomes lost down the elevator shaft. Presuming such items survive the fall down to the bottom of the elevator shaft, they are not easily retrieved. This can represent an inconvenience to the owner of the item, as well as the building owner and maintenance staff.

Therefore, an improved gap protective device that is capable of retrieving dropped items and reducing the likelihood the dropped object interferes with other elevator components is desired.

### SUMMARY OF THE DISCLOSED EMBODIMENTS

In one aspect, a transportation system is provided. The transportation system includes at least one shaft including a plurality of landing platforms, at least one transportation vehicle disposed in the at least one shaft, a protective device comprising a proximal end and a distal end, wherein the protective device is operably coupled to at least one of the transportation vehicle and the shaft adjacent to each of the plurality of landing platforms. In an embodiment, each transportation vehicle includes a vehicle floor and each landing platform includes a platform floor such that a gap is created when the vehicle floor is positioned adjacent to the platform floor.

In an embodiment, the protective device includes a device width, wherein the device width is greater than or equal to a width of the gap. In an embodiment, the protective device is operably coupled to at least one of an upper exterior portion of the transportation vehicle, a lower exterior portion of the transportation vehicle, and an interior surface of the shaft beneath the platform floor.

In an embodiment, the at least one transportation vehicle includes a vehicle door system configured to be placed in an open position and a closed position. In an embodiment, each of the plurality of landing platforms includes a platform door system configured to be placed in an open position and a closed position.

In an embodiment, the transportation system further includes an actuation device operably coupled to the protective device and at least one of the vehicle door system and platform door system, wherein the actuation device places the protective device in a first position when at least one of the vehicle door system and platform door system is in the open position and in a second position when at least one of the vehicle door system and platform door system is in the closed position. In an embodiment, the first position includes a position such that the protective device is disposed beneath the gap.

In an embodiment, the transportation system further includes a collection vessel positioned adjacent to at least one of the proximal end and the distal end of the protective device. In an embodiment, the proximal end is positioned higher than the distal end. In an embodiment, the collection vessel is configured to be accessible from an exterior of the shaft.

In an embodiment, the transportation system further includes a conduit operably coupled to the collection vessel. In an embodiment, a retrieval vessel operably coupled to the conduit.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic diagram of an exemplary elevator system, constructed in accordance with an aspect of the present disclosure;

FIG. 2 is a cross-sectional diagram of an exemplary elevator system, constructed in accordance with an aspect of the present disclosure;

FIG. 3 is a perspective view of an exemplary elevator system with a protective device, constructed in accordance with an aspect of the present disclosure; and

FIG. 4 is a front view of an exemplary elevator system with a protective device, constructed in accordance with an aspect of the present disclosure.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

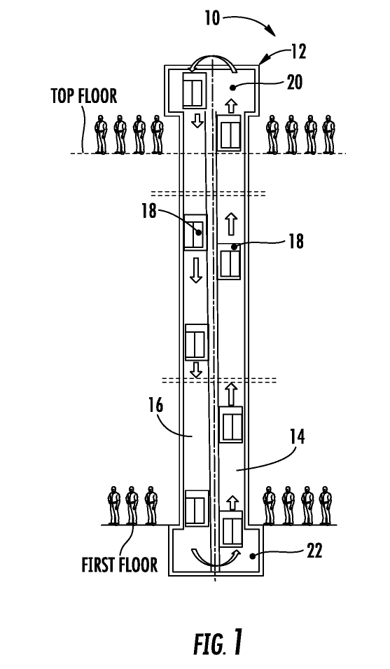

Referring now to FIG. 1, a transportation system 10 is shown in schematic fashion. It is to be understood that the exemplary version of the transportation system 10 includes an elevator system shown in FIG. 1 for illustrative purposes only and to present background for the various components of a general elevator system. Moreover, it should be understood that the present system is described with respect to an elevator system, the system is equally applicable to any transportation system having sliding doors, a platform, and a gap there between including, but not limited to, a subway, train, or tram.

As shown in FIG. 1, the transportation system 10 includes a shaft 12. In the embodiment shown, the shaft 12 includes a first shaft portion 14 and a second shaft portion 16. The first and second shaft portions 14, 16 may each be disposed vertically within a multi-story building.

The first and second shaft portions 14, 16 may be dedicated to directional travel. In some embodiments, the first and second shaft portions 14, 16 may be part of a single open shaft 12. In other embodiments, the first and second shaft portions 14, 16 may be part of a divided shaft 12 that has a wall or other divider between the first and second shaft portions 14, 16. The shaft 12 is not limited to two shaft portions. In some embodiments, the shaft 12 may include a single shaft or more than two shaft portions disposed vertically within a multi-story building.

In other embodiments, the shaft 12 may be disposed horizontally, such as in a subway tunnel to name one non-limiting example. The horizontal shaft 12 may or may not include walls or dividers for the entire length of the shaft 12.

In the embodiment illustrated in FIG. 1, transportation vehicles 18 (e.g. elevator cars) may travel upward in the first shaft portion 14. Transportation vehicles 18 may travel downward in the second shaft portion 16. Exemplary transportation system 10 transports transportation vehicles 18 from a first floor to an upper floor in the first shaft portion 14 and transports transportation vehicles 18 from an upper floor to the first floor in the second shaft portion 16. Above the top floor is an upper transfer station 20 where transportation vehicles 18 from the first shaft portion 14 are moved to the second shaft portion 16 as described in further detail herein. It is understood that the upper transfer station 20 may be located at the top floor, rather than above the top floor. Below the first floor is a lower transfer station 22 where transportation vehicles 18 from the second shaft portion 16 are moved to the first shaft portion 14. It is understood that lower transfer station 22 may be located at the first floor, rather than below the first floor. Although not shown in FIG. 1, transportation vehicles 18 may stop at intermediate floors to allow ingress to and egress from the transportation vehicle 18.

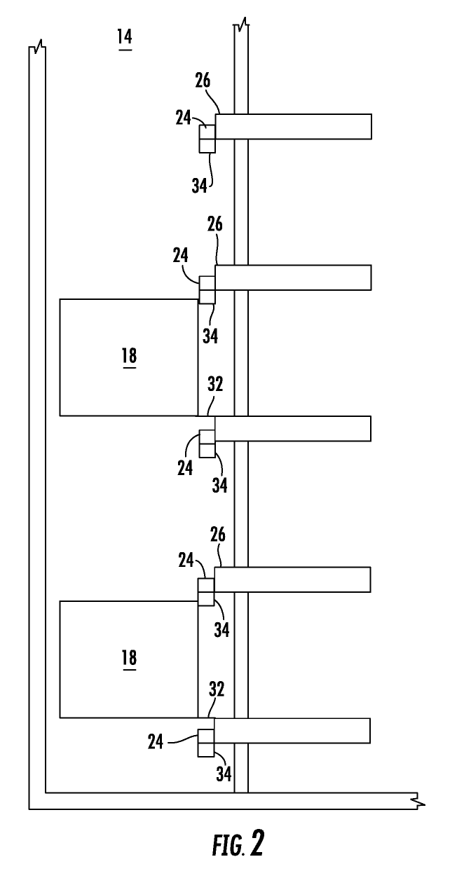

FIG. 2 depicts cross-sectional view of the exemplary embodiment of the transportation system 10. In this embodiment, the transportation system 10 includes a protective device 24 disposed within the shaft 12.

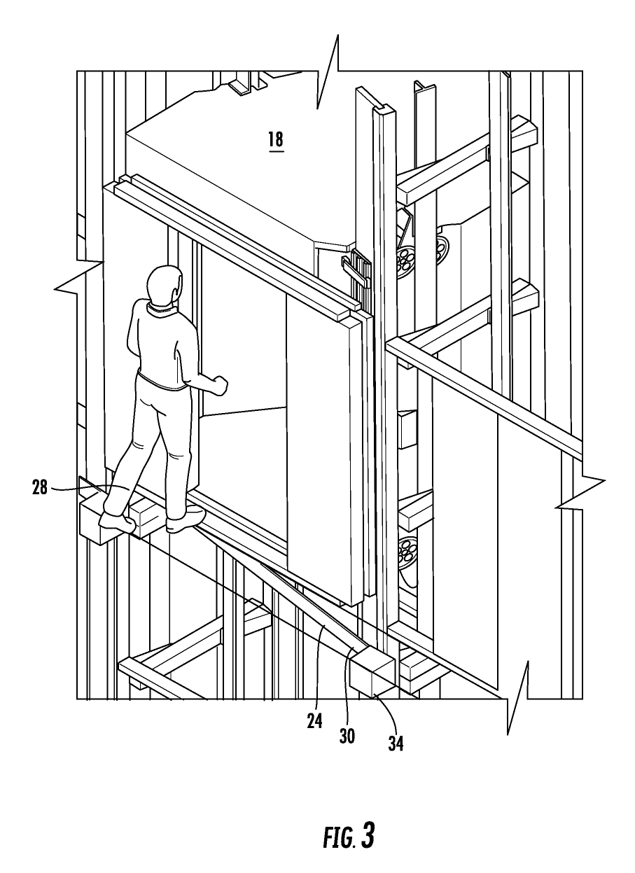

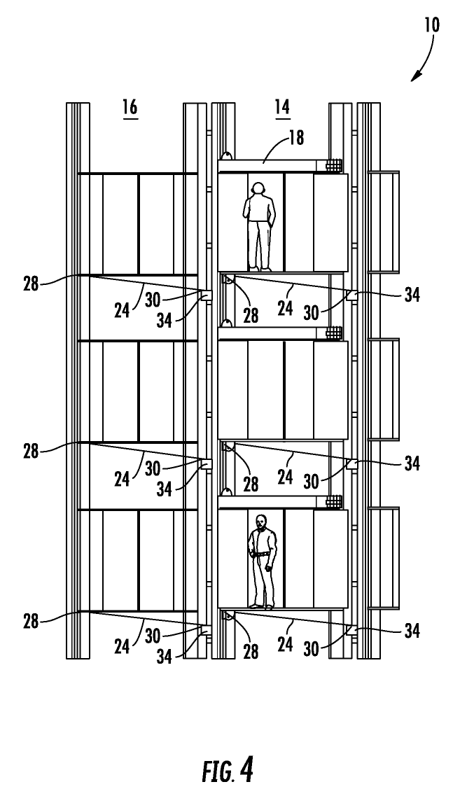

The protective device 24 includes a proximal end 28 and a distal end 30 (shown in FIGS. 3 and 4). In one embodiment, the protective device 24 may be disposed at each landing platform 26 located adjacent to the shaft 12. In such an embodiment, the protective device 24 is operably coupled to a portion of the landing platform 26. In this embodiment, as explained below, the protective device 24 provides a means for capturing and retrieving dropped items while the transportation vehicle 18 is stationary at the landing platform 26.

In other embodiments, a protective device 24 may be operably coupled to the transportation vehicle 18. In an embodiment, the protective device 24 may be disposed on at least one of an upper portion and a lower portion of the transportation vehicle 18. For example, the protective device 24 may be operably coupled along an exterior perimeter of the roof of an elevator car or the protective device 24 may be operably coupled on the exterior of the transportation vehicle 18 in an area below where a passenger would enter and exit the transportation vehicle 18 (as later described herein).

In an exemplary embodiment of the protective device 24, the proximal end 28 is positioned higher than the distal end 30 causing the protective device 24 to have a decline orientation. It will be appreciated that orientation of the protective device 24 may be opposite such that the distal end 30 may be positioned higher than the proximal end 28. When a transportation vehicle 18 is positioned adjacent to a landing platform 26, such that a passenger may exit the transportation vehicle 18 onto the landing platform 26, a gap 32 is created between a floor of the transportation vehicle 18 and the floor of the landing platform 26. The protective device 24 is configured to be placed under the gap 32 in order to receive items that may be dropped within the gap 32.

In an embodiment, the protective device 24 includes a protective device width dimension (not shown) that is greater than or equal to the width of the gap 32; however, the protective device 24 may not be so wide as to interfere with the movement of the transportation vehicle 18 as it travels within the shaft 12. In the embodiments shown in FIGS. 3 and 4, the proximal end 28 of the protective device 24 is positioned higher than the distal end 30 creating a decline such that objects (e.g., keys, coins, tools, etc.) that may fall into the gap 32 may be directed away from moving parts of the transportation system 10 to reduce the likelihood of objects damaging components of the transportation system 10.

In other embodiments, the protective device 24 may be operably coupled to an actuation device (not shown), such that the protective device 24 may be deployed into the proper position when the transportation vehicle 18 is positioned at a landing platform 26. In one such embodiment, the actuation device may be operably coupled to the sliding doors such that when the sliding doors are in an open position, the protective device 24 is deployed in a position to be placed under the gap 32 in order to receive items that may be dropped within the gap 32.

In another embodiment, the actuation device may be operably coupled to a switching device (not shown). For example, service personnel may perform maintenance from the roof of the transportation vehicle 18. Upon placing the transportation vehicle 18 in a service mode, via actuation of the switching device, the protective device 24 may be deployed from the roof of the transportation vehicle to prevent tools or service components from falling down the shaft 12; thus, preventing damage to transportation vehicles 18 located below within the shaft 12.

In another example, where more than one transportation vehicles 18 occupies the same shaft 12, the protection device 24 operates to deflect objects dropped through the gap 32 from hitting, and perhaps damaging, a transportation vehicle 18 positioned below the landing platform 26 where the object is dropped.

In an embodiment, a collection vessel 34 is disposed at the lower of the proximal end 28 or the distal end 30 of the protective device 24. As shown in the embodiments of FIGS. 3 and 4, the collection vessel 30 is positioned such that as the fallen objects are directed down the decline of the protective device 24, the fallen objects are able to fall off of the distal end 30 into the collection vessel 34 to be retrieved in a safe manner.

In an embodiment, the collection vessel 34 may be accessible from an exterior of the shaft 12. In other embodiments, the collection vessel 34 may also be accessible from a transportation vehicle 18 designated to function as a service/maintenance car. For example, to increase safety of maintenance personnel and/or building operators, fallen objects may be retrieved from the collection vessel 34 by opening a hatch or a door, to name a couple of non-limiting examples, from the interior of the structure in which the transportation system 10 is located; thus, keeping unauthorized personnel from entering the shaft 12. In other embodiments, a conduit (not shown) may be operably coupled to the collection vessel 34 such that fallen objects may enter the conduit and be directed to a combined retrieval vessel (not shown) operably coupled thereto.

It will therefore be appreciated that the present transportation system 10 includes a protective device 24 configured to have a size corresponding to the width of the gap 32 between the floor of the transportation vehicle 18 and the floor of the landing platform 26, such that dropped objects that fall through the gap 18 may be collected and retrieved from the collection vessel 34 without building personnel entering the shaft 12. It will further be appreciated that the present transportation system 10 includes a protective device located along the exterior perimeter of the transportation vehicle 18 to collect items that may be dropped from the exterior roof of the transportation vehicle 18 during maintenance.

While the disclosure has been illustrated and described in detail in the drawings and foregoing description, the same is to be considered as illustrative and not restrictive in character, it being understood that only certain embodiments have been shown and described and that all changes and modifications that come within the spirit of the disclosure are desired to be protected.

What is claimed is:

1. A transportation system comprising:
at least one shaft including a plurality of landing platforms;
at least one transportation vehicle disposed in the at least one shaft,
a protective device comprising a proximal end and a distal end, wherein the protective device is operably coupled to at least one of the transportation vehicle and the shaft adjacent to each of the plurality of landing platforms.

2. The transportation system of claim 1, wherein each transportation vehicle comprises a vehicle floor and each landing platform comprises a platform floor such that a gap is created when the vehicle floor is positioned adjacent to the platform floor.

3. The transportation system of claim 2, wherein the protective device comprises a device width; wherein the device width is greater than or equal to a width of the gap.

4. The transportation system of claim 3, wherein the protective device is operably coupled to at least one of an upper exterior portion of the transportation vehicle, a lower exterior portion of the transportation vehicle, and an interior surface of the shaft beneath the platform floor.

5. The transportation system of claim 4, wherein the at least one transportation vehicle comprises a vehicle door system configured to be placed in an open position and a closed position.

6. The transportation system of claim 5, wherein each of the plurality of landing platforms comprise a platform door system configured to be placed in an open position and a closed position.

7. The transportation system of claim 6, further comprising an actuation device operably coupled to the protective device and at least one of the vehicle door system and platform door system, wherein the actuation device places the protective device in a first position when at least one of the vehicle door system and platform door system is in the open position and in a second position when at least one of the vehicle door system and platform door system is in the closed position.

8. The transportation system of claim 7, wherein the first position comprises a position such that the protective device is disposed beneath the gap.

9. The transportation system of claim 1, further comprising a collection vessel positioned adjacent to at least one of the proximal end and the distal end of the protective device.

10. The transportation system of claim 9, wherein the proximal end is positioned higher than the distal end.

11. The transportation system of claim 9, wherein the collection vessel is configured to be accessible from an exterior of the shaft.

12. The transportation system of claim 9, further comprising a conduit operably coupled to the collection vessel.

13. The transportation system of claim 12, further comprising a retrieval vessel operably coupled to the conduit.
